(19) United States
(12) Patent Application Publication
(10) Pub. No.: US 2011/0117323 A1
(43) Pub. Date: May 19, 2011

(54) SURFACE PROCESSING METHOD, MASK FOR SURFACE PROCESSING, AND OPTICAL DEVICE

(75) Inventor: Kimio Ichikawa, Kanagawa (JP)

(73) Assignee: FUJIFILM CORPORATION, Minato-ku, Tokyo (JP)

(21) Appl. No.: 13/003,575

(22) PCT Filed: Jun. 18, 2009
(86) PCT No.: PCT/JP2009/061132

§ 371 Date: Jan. 11, 2011

(30) Foreign Application Priority Data
Jul. 17, 2008 (JP) 2008-186346

(51) Int. Cl. C23F 1/04; C23F 1/08; B32B 3/00

(52) U.S. Cl. 428/156; 216/49; 216/43; 156/345.3; 216/24

(57) ABSTRACT

The present invention provides a surface processing method for forming recesses and protrusions on a surface of an object to be processed, at least including: a process for attaching a polymer film mask containing a binding resin and organic pigment particles which are contained in the binding resin on the surface of the object to be processed; and a process for etching the surface of the object to be processed to which the polymer film mask has been attached so as to form recesses and protrusions on the surface of the object to be processed. Also, the present invention provides a mask for surface processing used for the surface processing method.

### TECHNICAL FIELD

The present invention relates to a surface processing method for forming recesses and protrusions on a surface of an object to be processed by etching, and a mask for surface processing used for the surface processing method. In addition, the present invention relates to an optical device having a substrate processed by the surface processing method.

### BACKGROUND ART

Conventionally, in the field of optical devices, such as solar cells, LEDs, and flat panel displays, a process for forming recesses and protrusions on a surface of a substrate, through which light permeates, by etching has been performed for the purpose of suppressing a reflection phenomenon occurring when there is a large difference in refractive index at an interface, through which light permeates.

Meanwhile, in the field of semiconductor apparatus, a process for forming recesses and protrusions on a surface of a substrate has been performed to generate an anchor effect for the purpose of, for example, suppressing peeling-off of a thin film caused by an insufficient adhesion property between the thin film and a substrate.

As such, a process for forming recesses and protrusions on a surface of an object to be processed has been performed in a variety of fields, and a variety of proposals relating to a process that forms recesses and protrusions on a surface have been made (for example, Patent Documents 1 to 3).
[Patent Document 1] Japanese Patent Application Laid-Open (JP-A) No. 3-71677
[Patent Document 2] JP-A No. 2000-261008
[Patent Document 3] JP-A No. 2005-277295
[Patent Document 4] JP-A No. 2007-27564

### DISCLOSURE OF INVENTION

### Technical Problem

However, productivity is not sufficient in any of the above proposals.

For example, when particles are dispersed on a surface of an object to be processed and the surface of the object to be processed is etched using the particles as a mask as described in Patent Documents 2 and 4, it is difficult to form recesses and protrusions on the surface with a certain quality level since the particles cannot be distributed uniformly. Therefore, when the area to be processed is large, particles cannot be distributed rapidly and uniformly, which results in low productivity.

In addition, as described in Patent Document 3, when a coated film is formed by applying a coating liquid that contains particles onto a surface of an object to be processed and then the surface of the object to be processed is etched, the coating liquid must be applied in batches on the object to be processed. Therefore, careful attention must be paid to prevent sedimentation of the particles in the coating liquid. In addition, it is necessary to perform a drying process after the coating, and the productivity is low.

The present invention provides a surface processing method which enables forming recesses and protrusions on a surface of an object to be processed rapidly with little variation in the quality of processed products even when the object to be processed has a large area and which achieves excellent productivity, and provides a mask for surface processing used for the surface processing method. Furthermore, the present invention provides an optical device having a substrate processed by the surface processing method.

### Solution to Problem

The above problems are approached by the following means. That is, the present invention provides:

<1> a surface processing method for forming recesses and protrusions on a surface of an object to be processed, including:

attaching a polymer film mask on a surface of the object to be processed, the polymer film mask comprising a binding resin and organic pigment particles which are included in the binding resin, and

etching the surface of the object to be processed to which the polymer film mask has been attached to form recesses and protrusions on the surface of the object to be processed.

In addition, the present invention provides:

<2> the surface processing method according to <1>, wherein a ratio of a projected area of the organic pigment particles projected to a substrate to be processed in an etching direction with respect to a surface area of the substrate to be processed is from 5% to less than 60%.

In addition, the present invention provides:

<3> the surface processing method according to <1> or <2>, wherein a glass transition temperature of the binding resin is 50° C. or less.

In addition, the present invention provides:

<4> the surface processing method according to any one of <1> to <3>, wherein:

one principal surface of the polymer film mask is supported by a supporting substrate; and

the etching includes attaching the polymer film mask on the surface of the object to be processed so as to make the opposite surface to the principal surface face the object to be processed and then releasing the supporting substrate from the polymer film mask.

In addition, the present invention provides:

<5> the surface processing method according to <4>, wherein an adhesion force that acts between the polymer film mask and the supporting substrate is 5 N/10 mm or less at 25° C.

In addition, the present invention provides:

<6> the surface processing method according to <4> or <5>, wherein a thermoplastic resin layer having a thickness of less than 15 μm is placed between the polymer film mask and the supporting substrate.

In addition, the present invention provides:

<7> the surface processing method according to any one of <4> to <6>, wherein:

the surface of the polymer film mask opposite to the surface on which the supporting substrate is provided is covered with a protection film; and

the protection film is released from the polymer film mask before attaching the polymer film mask on the surface of the object to be processed.

In addition, the present invention provides:

<8> the surface processing method according to any one of <1> to <7>, wherein attaching the polymer film mask on the surface of the object to be processed includes attaching the polymer film mask and the object to be processed by pinching them with rollers under a condition of at least either of a vacuum or reduced pressure condition or a temperature condition higher than that of the glass transition temperature of the binding resin.

In addition, the present invention provides:

<9> the surface processing method according to any one of <1> to <8>, wherein the etching comprises dry etching.

In addition, the present invention provides:

<10> the surface processing method according to any one of <1> to <9>, wherein a ratio of a number of recess portions on the surface of the object to be processed having an equivalent diameter in a range of from 200 nm to 1,000 nm with respect to a total number of recess portions on the surface of the object to be processed is 60% or greater.

In addition, the present invention provides:

<11> the surface processing method according to any one of <1> to <10>, wherein the surface of the object to be processed on which recesses and protrusions are formed is a light incidence surface of an optical device.

In addition, the present invention provides:

<12> a mask for surface processing for forming recesses and protrusions on a surface of an object to be processed, including a polymer film mask comprising a binding resin and organic pigment particles which are included in the binding resin.

In addition, the present invention provides:

<13> the mask for surface processing according to <12>, further including a supporting substrate that supports one principal surface of the polymer film mask.

In addition, the present invention provides:

<14> the mask for surface processing according to <13>, wherein a thermoplastic resin layer having a thickness of less than 15 μm is placed between the polymer film mask and the supporting substrate.

In addition, the present invention provides:

<15> the mask for surface processing according to <13> or <14>, including a protection film that covers a surface of the polymer film mask opposite to the surface on which the supporting substrate is provided (the other principal surface).

In addition, the present invention provides:

<16> the mask for surface processing according to any one of <12> to <15>, wherein the mask is shaped as a roll or a sheet.

In addition, the present invention provides:

<17> an optical device, including a substrate that is the object to be processed which has been surface-processed by the surface processing method according to any one of <1> to <11>.

According to the present invention, there are provided a surface processing method which enables formation of recesses and protrusions on a surface of an object to be processed rapidly with little variation in the quality of processed products even when the object to be processed has a large area and which achieves excellent productivity, and a mask for surface processing used for the same.

### BRIEF DESCRIPTION OF DRAWINGS

FIG. 1A is a process chart explaining an embodiment of a surface processing method according to the present invention.

FIG. 1B is a process chart explaining the embodiment (the subsequent process of FIG. 1A).

FIG. 1C is a process chart explaining the embodiment (the subsequent process of FIG. 1B).

FIG. 1D is a process chart explaining the embodiment (the subsequent process of FIG. 1C).

FIG. 1E is a process chart explaining the embodiment (the subsequent process of FIG. 1D).

FIG. 1F is a process chart explaining the embodiment (the subsequent process of FIG. 1E).

FIG. 2A is a schematic configuration diagram (planar view) showing an embodiment of a mask for surface processing according to the present invention.

FIG. 2B is a schematic configuration diagram (cross-sectional view taken along the line A-A) showing the embodiment.

FIG. 3A is a perspective view explaining a shape (a roll shape) of the mask when the mask for surface processing shown in FIG. 2 is stored.

FIG. 3B is a perspective view explaining a shape (a stacked sheet shape) of the mask when the mask for surface processing in FIG. 2 is stored.

### BEST MODE FOR CARRYING OUT THE INVENTION

Hereinafter, embodiments of the present invention will be described with reference to the drawings. Meanwhile, there are cases in which members having substantially the same function and/or operation are given the same reference number through the entire drawings, and duplicate explanation may be omitted.

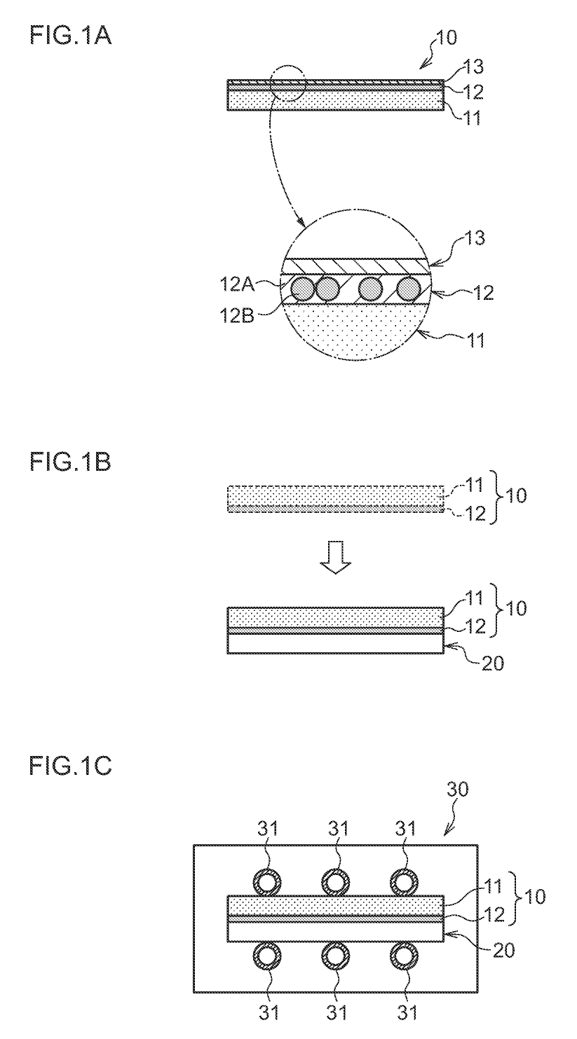

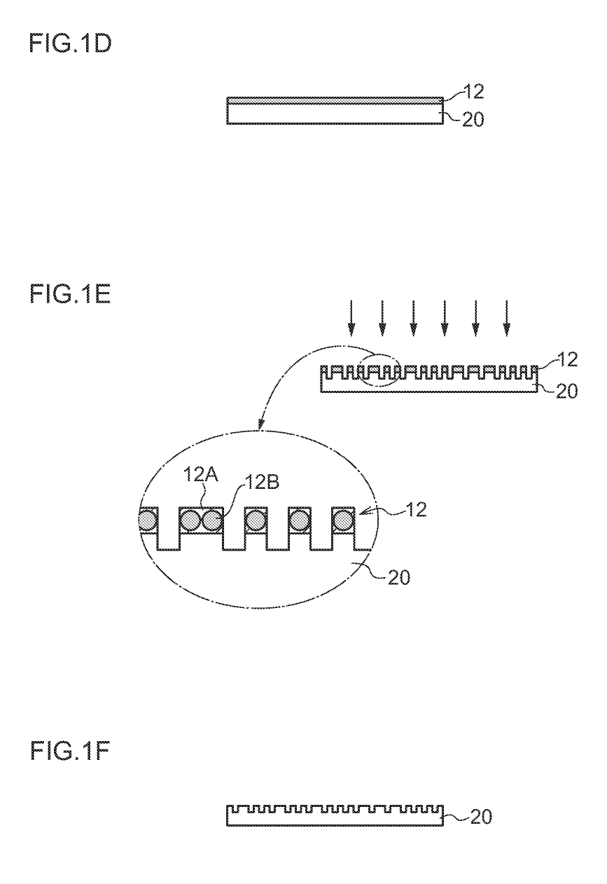

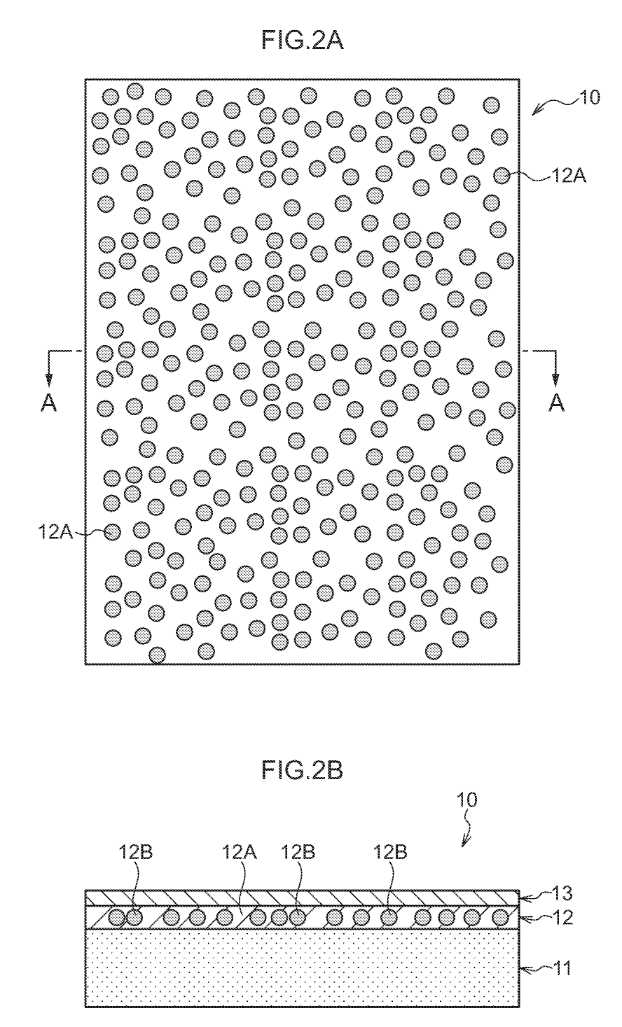

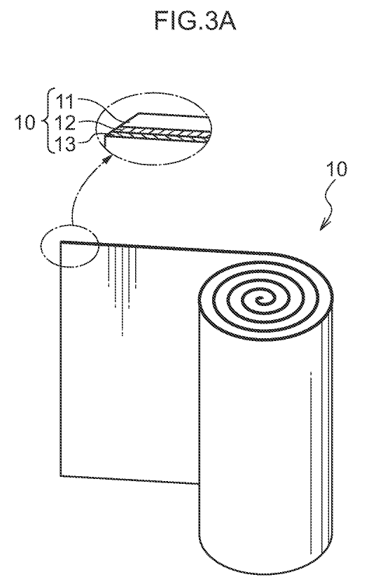

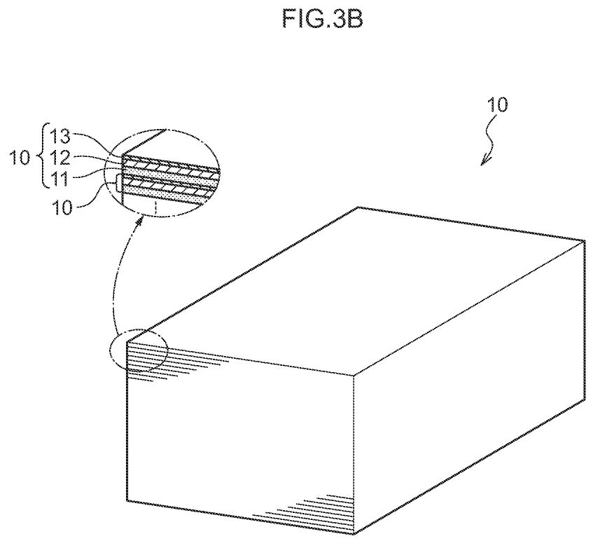

FIGS. 1A to 1F are process charts explaining an embodiment of the surface processing method according to the present invention. FIGS. 2A and 2B are schematic configuration diagrams showing an embodiment of the mask for surface processing according to the present invention. FIG. 2A is a planar view, and FIG. 2B is a cross-sectional view (taken along the line A-A). FIGS. 3A and 3B are perspective views explaining the shapes of the mask when the mask for surface processing shown in FIGS. 2A and 2B are stored. FIG. 3A shows a roll of the mask, and FIG. 3B shows sheet-shaped masks being stacked.

As shown in FIG. 1A, a mask for surface processing 10 is prepared. As shown in FIG. 2B, the mask for surface processing 10 has a polymer film mask 12 and a protection film 13 laminated sequentially on a supporting substrate 11. The polymer film mask 12 includes, for example, organic pigment particles 12B having etching resistance which are mixed and dispersed in a binding resin 12A. The details of the mask for surface processing 10 will be described below.

Next, as shown in FIG. 1B, after releasing the protection film 13 of the mask for surface processing 10, the exposed surface of the polymer film mask 12 is placed in contact with a substrate 20 to be processed (an object to be processed) so as to face the substrate 20, whereby the mask for surface processing 10 is laminated on the substrate 20 to be processed. Thus, the polymer film mask 12 in the mask for surface processing 10 is tightly adhered on a surface of the substrate 20 to be processed.

The substrate 20 to be processed is not particularly limited, and may be, for example, a substrate which is composed of a semiconductor (for example, a silicon substrate), a conductive material, or an insulating material; a glass substrate used for a flat panel display; and an object having a functional layer (for example, a wiring layer or an electrical insulating layer) formed on the substrate.

Next, as shown in FIG. 1C, the substrate 20 to be processed on which the mask for surface processing 10 has been laminated is inserted into a laminating apparatus 30. Then, for example, the substrate 20 to be processed on which the mask for surface processing 10 has been laminated is pinched between cylindrical pinch rollers 31 provided in the laminating apparatus 30 so as to provide a pressure between the mask for surface processing 10 and the substrate 20 to be processed, that is, between the polymer film mask 12 and the substrate 20 to be processed. (The number of the pinch rollers is not particularly limited. The present embodiment shows a case of using three pairs of rollers.) Thus, the mask for surface processing 10 and the substrate 20 to be processed, that is, the polymer film mask 12 and the substrate 20 to be processed are welded.

It is desirable to perform the welding using the pinch rollers 31 under a condition of at least either of a vacuum and reduced pressure condition (for example, a vacuum or reduced pressure condition of 100 hPa or less) or a temperature condition higher than that of the glass transition temperature of the binding resin 12A in the polymer film mask 1. Specifically, for example, from the viewpoints of improving the adherence between the polymer film mask 12 and the substrate 20 to be processed (that is, the viewpoints of suppressing inclusion of air bubbles), it is desirable to perform the welding under a vacuum or reduced pressure condition. Meanwhile, when the glass transition temperature of the binding resin 12A that is a component of the polymer film mask 12 is higher than the manufacturing environment (typically, room temperature, for example, 25° C.), it is desirable to perform the welding under a condition of a higher temperature than the glass transition temperature of the binding resin 12A.

In a preferable welding condition, welding is carried out with a pressure to the pinch rollers 31 of from 20 psi to 50 psi, at a temperature of from 50° C. to 150° C. and an atmospheric pressure of 10 hPa, at a speed of from 0.1 m/min. to 3 m/min. From the viewpoints of the productivity, it is preferable to perform the welding process consecutively, and, in such a case, a well-known consecutive processing vacuum laminator can be used.

Meanwhile, when the welding process accompanies a heating process (that is, when welding is carried out under a higher temperature condition than the glass transition temperature of the binding resin 12A), a source of heat (not shown) may be provided inside the pinch rollers, or a source of heat may be provided at a separate position from the pinch rollers.

Next, as shown in FIG. 1D, the supporting substrate 11 is released from the substrate 20 to be processed on which the mask for surface processing 10 (the polymer film mask 12) has been welded. Thus, only the polymer film mask 12 is left on the surface of the substrate 20 to be processed. Meanwhile, the supporting substrate 11 may be released before the welding process using the pinch rollers 31 (the laminating apparatus 30). In this case, it is preferable that, among the pinch rollers 31, the surfaces of the rollers that are arranged to contact the mask for surface processing 10 (the upper rollers shown in FIG. 1C), are formed from a material having a good mold-releasing property (for example, polytetrafluoroethylene).

Examples of the method for releasing the supporting substrate using a releasing apparatus include a releasing method including attaching a pressure-sensitive adhesive tape to the front end of the protection film, a releasing method including blowing compressed air to the front end of the protection film, and a releasing method including applying a laser light.

Next, as shown in FIG. 1E, etching is performed on the polymer film mask 12 side of the substrate 20 to be processed on which the polymer film mask 12 has been attached. As a result, while the areas on the surface of the substrate 20 to be processed other than the areas covered with the organic pigment particles 12B that are a component of the polymer film mask 12 (i.e., the areas, on the substrate 20 to be processed, onto which the organic pigment particles 12B are projected when seen from the etching direction) are etched, whereby recess portions are formed, the areas covered with the organic pigment particles 12B on the surface of the substrate 20 to be processed are not etched. That is, the etched areas form the recess portions, and the un-etched areas form protrusion portions, whereby recesses and protrusions are formed on the surface of the substrate 20 to be processed. Meanwhile, in the areas to be etched (i.e., the areas other than the areas covered with the organic pigment particles 12B), the surface of the substrate 20 to be processed is etched together with the polymer film mask 12.

The etching may be either a wet etching or a dry etching, but a dry etching is preferable. Examples of the dry etching method include a well-known dry etching, such as a reactive gas in which etching is carried out by exposing the substrate 20 to be processed in a reactive gas, or a Reactive Ion Etching (RIE) in which etching is carried out by ionizing or radicalizing the reactive gas with plasma. In addition, as an apparatus for performing a dry etching, a well-known apparatus is used.

The conditions for performing dry etching are properly set according to the thickness and/or kind of the polymer film mask 12 (for example, the kind of the binding resin or the organic pigment particles), but the preferable conditions are as follows:

1) It is possible to use, for example, CF₄, C₂F₆, Cl₂ and ClF₃ as the reactive gas for a dry etching.

2) Preferable examples of a highly anisotropic etching method include the RIE and the Reactive Ion Beam Etching (RIBE) that use a gas of, for example, SiCl₄+He or CH₄+He.

3) There are some cases according to the kind of etching gas in which the etching gas infiltrates into the substrate to be processed and causes chemical and physical changes; therefore, considering such cases, exposure time of the substrate to be processed in the etching gas can be optimized.

4) When part of the polymer film mask is left after desired recesses and protrusions have been obtained by etching, it is possible to use an ashing method that injects a gas of, for example, ozone or oxygen and applies a light of, for example, ultraviolet rays so as to remove the residue, or an ashing method that turns oxygen gas into plasma using, for example, a high frequency radiation and uses the plasma so as to remove the residue.

Next, as shown in FIG. 1F, the polymer film mask 12 is released (removed) from the etched substrate 20 to be processed.

Through the above processes, the processing for forming recesses and protrusions are performed on the surface of the substrate 20 to be processed.

In the surface processing method according to the present embodiment as described above, the substrate 20 to be processed is etched in a state in which the polymer film mask 12 containing the organic pigment particles having the etching resistance, as the mask for surface processing 10, is attached to the substrate 20 to be processed. The areas, on the substrate 20 to be processed, which are covered with the organic pigment particles 12B, which are a component of the polymer film mask 12, are not etched, and the areas other than the areas covered with the organic pigment particles are etched; as a result, the surface of the substrate 20 to be processed forms recesses and protrusions.

The organic pigment particles 12B are arranged on the surface of the substrate 20 to be processed by previously mixing and dispersing the organic pigment particles that contribute to selection of the areas to be etched and the areas not to be etched into a binding resin and attaching a polymer film mask 12, which is obtained by forming the resultant product into a film, to the substrate 20 to be processed. Therefore, even when the surface of the substrate 20 to be processed has a large area, the organic pigment particles 12B are disposed on the surface of the substrate 20 to be processed by a simple and rapid operation of attaching the polymer film mask 12. Furthermore, since the polymer film mask 12 can be manufactured by an operation of mixing and dispersing the organic pigment particles 12B in the binding resin 12A, a mask having a certain uniform quality (that is, the dispersion state of the organic pigment particles 12B in the binding resin 12A is uniform to some extent) can be manufactured easily.

Consequently, the surface processing method according to the embodiment is a surface processing method which enables forming recesses and protrusions on the substrate 20 to be processed rapidly with little variation in the quality of the surface-processed products even when the object to be processed has a large area, and which exerts excellent productivity.

Meanwhile, on the surface of the substrate 20 to be processed (an object to be processed, for example, the light incidence surface of a solar cell) processed by the surface processing method according to the present embodiment, the ratio of the number of the recess portions on the surface of the object to be processed, which have equivalent diameters in a range of from 200 nm to 1,000 nm, with respect to the total number of the recess portions is preferably at least 60%, and still more preferably at least 80%.

The equivalent diameter will be defined as follows. Specifically, the surface shapes of the recess portions on the processed surface of the object to be processed are measured using a contact-type surface shape measuring apparatus, such as a surface roughness meter, or a noncontact-type surface shape measuring apparatus, such as an atomic force microscope (AFM); and the non-surface processed area, that is, the flat area where no recess or protrusion is present is defined as the reference surface, and the area surrounded by a line (closed curve) drawn on the inside surface of the recess portion at 10% depth from the reference surface toward the bottom of the recess portion is obtained. The diameter of a circle (an imaginary circle) having the same area as the above area is defined as an equivalent diameter. In the present invention, recess portions having an equivalent diameter of 10 nm or less are regarded as flat areas (i.e., areas where no recess or protrusion is formed) (that is, they do not count toward the number of the recess portions).

For example, when the ratio of the number of the recess portions having a predetermined equivalent diameter with respect to the total number of the recess portions on the light incidence surface of a solar cell is measured, the actually measured number of the recess portions is preferably at least 10, more preferably 50 or more, still more preferably 100 or more, and most preferably 500 or more.

Specific examples of the area measuring and calculating method are as described in the following. That is, in the contour drawing of the shape measurement results measured by the AFM in a noncontact mode, if the depth at the deepest point z0 is obtained, and the 10% value of the z0 is defined as 0.1*z0, the depth zij at each measurement point (i, j) is given as zij=zij−0.1*z0. When another contour drawing is made based on the zji and printed out, the aforementioned area is obtained with a known method from the printed out drawing. Meanwhile, it is also possible to perform a data process with digital data directly at the AFM measuring apparatus so as to obtain the surface, and all conventional methods may be used.

Hereinafter, the mask for surface processing 10 that is used for the surface processing method according to the present embodiment will be described in detail. In the following, the description will be made with the reference numbers omitted.

The mask for surface processing includes a polymer film mask and a protection film sequentially laminated on a supporting substrate (see FIGS. 2A and 2B). That is, the mask for surface processing includes the polymer film mask, the supporting substrate that supports the polymer film mask at one surface, and the protection film that is coated on the other surface of the polymer film mask to protect the polymer film mask.

Herein, the mask for surface processing may have any configuration as long as it includes the polymer film mask. Specifically, for example, if the polymer film mask itself has a self-supporting property, the mask for surface processing may include only the polymer film mask and the protection film. For example, when there is no need to worry about the occurrence of damage or attachments on the polymer film mask, the mask for surface processing may include solely the polymer film mask.

The polymer film will be described.

Typically, the polymer film mask includes a binding resin and organic pigment particles which are mixed in the binding resin. The polymer film mask may include other additives.

The thickness of the polymer film mask is preferably from 0.1 μm to 5 μm, and more preferably from 0.5 μm to 2 μm.

The coverage of the organic pigment particles in the polymer film mask with respect to the object to be processed is preferably from 5% to less than 60%, and more preferably from 10% to 50%, and still more preferably from 20% to 40%. The coverage is selected by the degree of the etched areas for forming recesses and protrusions and is preferably in the above range from the viewpoints of the strength of the polymer film mask (for example, breakage prevention when released from the substrate to be processed).

Here, the specification of the processing for forming recesses and protrusions on the surface of the substrate to be processed, that is, the diameter (equivalent diameter), depth, and processed surface ratio of the recess portions on the etched surface can be set arbitrarily depending on the coverage and the average particle diameter of the organic pigment particles in the polymer film mask.

Meanwhile, the coverage refers to the ratio of the substrate to be processed which is covered with the organic pigment particles when the polymer film mask is attached to the substrate to be preprocessed. That is, the coverage indicates the ratio of the projected areas of the organic pigment particles projected to the substrate to be processed from the etching direction with respect to the surface area of the substrate to be processed. The coverage may be calculated based on the projected areas after the polymer film mask has been attached to the substrate to be preprocessed by observing the surface using a scanning electron microscope (SEM) or an optical microscope and measuring the projected areas. When a SEM is used, it is preferable to observe the samples as they are without applying any surface processing.

Examples of the binding resin that is a component of the polymer film mask include a water-soluble polymer material and an organic solvent-soluble polymer material. Depending on the manufacturing method of the polymer film mask, it is possible to mix polymerizable monomers that form each of the polymer materials and other components that compose the polymer film mask, and then form a film by a light- or heat-induced polymerization reaction. Examples of such polymerizable monomers include (meth)acrylic monomers such as (meth)acrylic acid C1-C12 alkyl ester, and compounds well-known as acrylic modifiers having the affinity therewith. Examples of acrylic modifiers include a carboxyl-containing monomer and an acid anhydride-containing monomer. These polymerizable monomers may be polymerized by a well-known polymerization method, and an initiator, chain transfer agent, oligomer material, surfactant, or the like necessary for the polymerization may be appropriately selected from well-known materials. In addition, examples of the polymerizable monomers include well-known epoxy monomers and isocyanate monomers.

More specifically, examples of the binding resin preferably include a resin having a glass transition temperature of from −100° C. to 50° C., a number average molecular weight of from 1,000 to 200,000, and preferably from 5,000 to 100,000, and a degree of polymerization of about from 50 to 1,000. Examples of such a binding resin include a polymer or copolymer containing as a constituent unit, for example, vinyl chloride, vinyl acetate, vinyl alcohol, maleic acid, acrylic acid, acrylic acid ester, vinylidene chloride, acrylonitrile, methacrylic acid, methacrylic acid ester, styrene, butadiene, ethylene, vinyl butyral, vinyl acetal, and vinyl ether; a polyurethane resin; various gum resins; and a modified polyvinyl alcohol having a weight-average molecular weight of 100,000 or less.

In addition, preferable examples of the binding resin also include a thermosetting resin and a reactive resin. Examples of the thermosetting resin and the reactive resin include a phenol resin, an epoxy resin, a polyurethane curable resin, a urea resin, a melamine resin, an alkyd resin, an acrylic reactive resin, a formaldehyde resin, a silicone resin, an epoxy-polyamide resin, a mixture of a polyester resin and isocyanate prepolymer, a mixture of polyester polyol and polyisocyanate, and a mixture of a polyurethane resin and polyisocyanate. Such resins are described in detail in “Plastic Handbook (published by Asakura Publishing Co., Ltd.).” In addition, a well-know electron ray curable resin may be used. The above resins may be used alone or as a mixture.

Here, the polyurethane resins may have a known structure such as polyester polyurethane, polyether polyurethane, polyether polyester polyurethane, polycarbonate polyurethane, polyester polycarbonate polyurethane, or polycaprolactone polyurethane. As for all of the aforementioned polyurethane resins, in order to obtain improved dispersion property and durability, if necessary, it is preferable to use one into which at least one polar group has been introduced by a copolymerization or addition reaction, the polar group being selected from —COOM, —SO₃M, —OSO₃M, —P═O(OM)₂, —O—P═O(OM)₂, (wherein, M represents a hydrogen atom or an alkali metal), —NR₂, —N+R₃ (wherein R represents a hydrocarbon group), an epoxy group, —SH, —CN, and the like. The amount of such polar group(s) is from 10⁻⁸ mol/g to 10⁻¹ mol/g, and preferably from 10⁻⁶ mol/g to 10⁻² mol/g. It is preferable that the polyurethane resin have at least one OH group at each of the molecular ends of polyurethane, thus two or more in total, in addition to the above polar group(s). Since the OH group cross-links with the polyisocyanate, as a curing agent, so as to form a three-dimensional network structure, it is preferable to include a larger number of OH groups in the molecule. Particularly, it is preferable that OH groups are present at the molecular ends, since the reactivity of the polyurethane resin with the curing agent becomes stronger. The number of OH groups present at the molecular ends of the polyurethane is preferably three or more, and particularly preferably four or more.

Meanwhile, examples of the polyisocyanate include isocyanates such as tolylenediisocyanate, 4,4′-diphenylmethanediisocyanate, hexamethylenediisocyanate, xylylenediisocyanate, naphthylene-1,5-diisocyanate, o-toluidinediisocyanate, isophorondiisocyanate, and triphenylmethanetriisocyanate; a product of such isocyanates and a polyalcohol; and polyisocyanates produced by the condensation of isocyanates. Examples of the commercial products of such isocyanates include CORONATE L, CORONATE HL, CORONATE 2030, CORONATE 2031, MILIONATE MR, MILIONATE MTL (all of them are trade names, manufactured by Nippon Polyurethane Industry Co., Ltd.); TAKENATE D-102, TAKENATE D-110N, TAKENATE D-200, TAKENATE D-202, (all of them are trade names, manufactured by Takeda Pharmaceutical Company Limited); and DESMODUR L, DESMODUR IL, DESMODUR N, DESMODUR HL (all of them are trade names, manufactured by Sumika Bayer Co., Ltd.). Theses commercial products can be used in any of the layers, alone or as a mixture of two or more thereof by using the difference in the curing reactivity.

The glass transition temperature of the binding resin is preferably 50° C. or less, and more preferably from −60° C. to 30° C., and more preferably from −50° C. to 30° C. The glass transition temperature is preferably in the above ranges from the viewpoints of the storage property of the polymer film mask (the mask for surface processing), the handling property in the recess and protrusion forming processing, and the improvement in the adhesion property with the substrate to be processed.

Here, the glass transition temperature may be measured by using a known thermal analysis apparatus or a mechanical characteristics-measuring apparatus using the polymer film mask material as a sample. It is preferable to measure using a dynamic viscoelastic measuring apparatus in a bending mode at a measurement frequency of 1 Hz and a rate of temperature rise of 5° C./min.

Examples of the organic pigment particles that is a component of the polymer film mask are not particularly limited as long as they have etching resistance, and examples thereof include capsule particles containing an organic colorant and organic dye/pigment particles.

Examples of the organic dye/pigment particles include an azo compound, a complex compound of an azo compound and a metal ion, a phthalocyanine compound, a metal element-containing phthalocyanine compound, a cyanine compound, a merocyanine compound, an oxonol compound, a styryl compound, and an anthraquinone compound. The structures thereof are not defined, but examples of the structures include those of various pigments as described in “Technologies and Market of Industrial Pigments (published in 1978 by CMC INC.)” or “Coloring Materials Engineering Handbook (organized by Japan Society of Colour Material and published by ASAMURA Publishing Co., Ltd. in 1989)”. Among the pigments, preferable examples of the pigments having a high etching resistance include a pigment having a cyclic structure in the molecule, a pigment having a low oxygen element ratio, and a pigment containing a heavy element such as metal.

Examples of the capsule particles containing an organic colorant include particles capsulated by dissolving a colorant in an organic liquid and coating it with a polyurethane resin, but capsule particles containing a colorant precipitated in the capsule are preferable.

The specific gravity of the organic pigment particles is preferably 2.0 or less, and more preferably 1.8 or less, and most preferably 1.6 or less, in order to prevent the sedimentation in the coating liquid.

The average particle diameter of the organic pigment particles is preferably 1 μm or less, and more preferably from 0.05 μm to 1.0 μm. The average particle diameter is preferably in the above ranges from the viewpoints of making the polymer film mask thinner.

Here, the average particle diameter of the organic pigment particles refers to the particle diameter obtained by the dynamic light scattering method. The measuring method is described as follows. By the dynamic light scattering method, the particle diameter and the particle size distribution in the submicron or finer ranges can be measured. Particles to be measured or a dispersion liquid thereof is dispersed by a known method such as ultrasonic wave application in a medium, and then appropriately diluted so as to produce a measurement sample. In the cumulative frequency curve of the particle diameter obtained by the dynamic light scattering method, the particle diameter at the cumulative frequency of 50% can be set as the average particle diameter. In a substantially similar manner, the ratio of the particle diameter at the cumulative frequency of 10% to the particle diameter at the cumulative frequency of 90% can be set as an index of the particle size distribution. Examples of the measuring apparatus adopting such a principle can include LB-500 (trade name, manufactured by Horiba, Ltd.).

The particle size distribution of the organic pigment particles is preferably from 2 to 50, and more preferably from 2 to 10. The particle size distribution in the above ranges leads to an easier formation of a flat polymer film mask layer and easier realization of a uniform surface processing without making the maximum average particle diameter too large.

The mixing amount of the binding resin is properly set according to the coverage or the dispersion property of the organic pigment particles, but, for example, is preferably from 5% by weight to 50% by weight, and more preferably from 10% by weight to 30% by weight, with respect to the organic pigment particles.

Examples of the other additives composing the polymer film mask include a dispersing agent that can disperse the organic pigment particles stably, a releasing agent that adjusts the adhesion force with the supporting substrate or the protection coating, a surfactant that adjusts the viscosity or surface tension of the coating liquid at the time of manufacturing, and a solvent.

Particularly, examples of the dispersing agent include phenylphosphonic acid, and specific examples thereof include “PPA” (trade name, manufactured by Nissan Chemical Industries, Ltd.), α-naphthyl phosphate, phenylphosphate, diphenylphosphate, p-ethylbenzene phosphonic acid, phenylphosphinic acid, aminoquinones, various silane coupling agents, titanium coupling agents, and fluorine-containing alkyl sulfuric acid ester and alkali metal salts thereof. In addition, a nonionic surfactant such as alkylene oxide adducts, glycerin adducts, glycidol adducts, or alkyl phenol ethylene oxide adducts; a cation surfactant such as cyclic amines, ester amides, quaternized ammonium salts, hydantoin derivatives, hetero rings, phosphoniums or sulfoniums; an anionic surfactant containing an acidic group, such as a carboxylic acid, sulfonic acid, phosphoric acid, phosphonic acid, a sulfuric acid ester group, or a phosphoric acid ester group; and an amphoteric surfactant such as amino acids, amino sulfonic acids, sulfuric acid or phosphoric acid esters of amino alcohols, or alkyl betaines. These surfactants are described in detail in “Handbook of Surfactant (published by San-to Publishing Co., Ltd.).” The lubricant and antistatic agent do not have to be completely pure, and may contain such impurities as isomers, unreactants, by-products, resolvents, and oxides, in addition to the essential components. The content of these impurities is preferably 30% by mass or less with respect to the total weight of the lubricant agent and the antistatic agent, and more preferably 10% by mass or less. The present invention preferably uses a mixture of monoesters and diester as described in the pamphlet of WO No. 98/35345 as the fatty acid ester.

In addition, it is preferable that a thermoplastic resin layer having a thickness of less than 15 μm (preferably less than 5 μm) is present between the polymer film mask and the supporting substrate. That is, it is preferable that a thermoplastic resin is interposed between the binding resin composing the polymer film mask and the supporting substrate. Preferable examples of a thermoplastic resin composing the thermoplastic resin layer include a binding resin that is a component of the polymer film mask, but it is preferable that the glass transition temperature of the thermoplastic resin composing the thermoplastic resin layer is 10° C. to 50° C. higher than the glass transition temperature of the binding resin composing the polymer film mask. The glass transition temperature being in the above range makes it difficult to generate defects, such as cracking, in the thermoplastic resin layer, which is an intermediate layer in the welding process to the substrate to be processed, and, in addition, makes it easier to release the thermoplastic resin layer from the supporting substrate. In addition, when the thickness of the thermoplastic resin layer is in the above range, the degradation of the productivity caused by an increase in the processing time of the etching process is suppressed.

Supporting Substrate

As the supporting substrate, for example, a resin film is used. Examples of such a resin film include a resin film formed from a polyester (for example, polyethylene terephthalate or polyethylene naphthalate), polyphenylene sulfide, polyimide, or a mixture thereof. The peeling property of the polymer film mask can be optimized by properly controlling interface energy of the surface of the supporting substrate on which the polymer film mask is to be formed. As an example of an interface energy controlling method, it is preferable to form a silicon releasing agent layer, and specific examples of the method include application of a silicon surfactant, and formation of a curable coating layer of an ionized radiation polymerizable silicon monomer or a coating layer of an organosiloxane polymer. Examples of the interface energy controlling method also include application of a fluorine-containing surfactant.

The thickness of the supporting substrate is preferably from 30 μm to 300 μm, and more preferably from 50 μm to 100 μm. The thickness is preferably in the above ranges from the viewpoints of imparting a self-supporting property to the mask for surface processing and of improving the handling property when the mask is stored or attached to the substrate to be processed.

The adhesion force that acts between the supporting substrate and the polymer film mask is preferably lower than the adhesion force between the polymer film mask and the substrate to be processed (the adhesion force that acts when the supporting substrate is released from the polymer film mask). Accordingly, the release of the polymer film mask from the substrate to be processed is suppressed when the supporting substrate is released from the polymer film mask.

The adhesion force between the supporting substrate and the polymer film mask is preferably 5 N/10 mm or less, and more preferably from 0.01 N/10 mm to 1N/10 mm, and further preferably from 0.05 N/10 mm to 1 N/10 mm.

Herein, the adhesion force may be measured by a method which is regulated by Japanese Industry Standards (JIS) or the American Society for Testing and Materials (ASTM) (known as the 180 Degree Adhesive Peel Strength Test), and refers to an average load necessary for peeling-off of a layer per unit width when the layer provided on a base body is pulled and peeled off at an angle of 180 degrees and a speed of 6 in/min (about 152.4 mm/min.) (ASTM D-903).

Protection Film

As the protection film, a polymer film formed from an aliphatic polymer or an aromatic polymer is used, and specific examples of the polymer film include a polyethylene film, a propylene film, and a polyethylene terephthalate film. The protection film may be composed solely of the polymer film or may further have a layer formed by coating with a polymer material which is called an adhesive, such as an acrylic material, gum material, or an ethylene vinyl material.

The thickness of the protection film is preferably from 30 μm to 100 μm, and more preferably from 40 μm to 70 μm. The thickness is preferably in the above ranges from the viewpoints of protecting the surface of the polymer film mask that is to be attached to the substrate to be processed and of improving the handling property of the mask for processing.

The adhesion force that acts between the protection film and the polymer film mask is preferably lower than the adhesion force between the polymer film mask and the supporting substrate (the adhesion force that acts when the protection film is released from the polymer film mask). Thereby, it is possible to suppress the release of the polymer film mask from the substrate to be processed when the protection film is released from the polymer film mask.

The adhesion force between the protection film and the polymer film mask is preferably 5 N/10 mm or less, and more preferably from 0.01 N/10 mm to 1N/10 mm, and further preferably from 0.05 N/10 mm to 1 N/10 mm. Meanwhile, when the protection film is not attached to the polymer film mask and just inserted as a so-called interleaving paper, the adhesion force between the protection film and the polymer film mask is substantially zero.

The mask for surface processing described above may be stored, traded, or used in a shape of a roll, as shown in FIG. 3A, or may be stored, traded, or used in a shape of a stacked sheet, as shown in FIG. 3B.

The surface processing method (the mask for surface processing) according to the present embodiment is, for example, preferably applied to the following recess and protrusion forming processing:

1) a recess and protrusion forming process for forming recesses and protrusions on a surface of a substrate, through which light permeates, by etching for the purpose of suppressing the reflection phenomenon occurring when there is a large difference in refractive index at an interface, through which light permeates, with respect to an optical device, such as a solar cell, an LED, and a flat panel display; and

2) a recess and protrusion forming process for forming recesses and protrusions on a surface of a substrate to generate an anchor effect for the purpose of, for example, suppressing the peeling-off of a thin film caused by an insufficient adhesion property between the thin film and a substrate in the field of a semiconductor apparatus.

Particularly, when the surface processing method (the mask for surface processing) according to the present embodiment is applied to the field of optical devices, it is preferable that the surface of an object to be processed (substrate) on which recesses and protrusions are to be formed is the light incidence surface of an optical device, because the reflection phenomenon in the optical device is suppressed with a good efficiency. Preferable examples of the optical device having an object to be processed that has been processed by the surface processing method according to the present embodiment include a solar cell having a substrate as the object to be processed. The solar cell may have a well-known configuration as long as it is characterized by having a substrate which has been processed by the surface processing method according to the present embodiment. For example, the solar cell may have a configuration having a substrate, a pair of electrodes, and a photovoltaic layer provided between the pair of electrodes.

Hereinafter, the present invention will be described in more detail with reference to examples. However, none of these examples limits the present invention.

### Example 1

First, a mask for surface processing was manufactured in the following manner.

A polyethylene terephthalate substrate (PET substrate) having a size of 300 mm×599 mm and a thickness of 50 μm was prepared. An ethyl acetate solution of a nonionic perfluoroalkyl group-containing surfactant was applied using a rod bar and dried on the surface of the PET substrate on which the following resin composition 1 was to be applied. Then, the following resin composition 1 was applied on the PET substrate and then heated at 50° C., whereby a 1.5 μm thick polymer film mask (a polyurethane urea film in which copper phthalocyanine particles are mixed and dispersed) was formed.

Resin Composition 1

5 parts by weight of polypropylene glycol 1000 (trade name, manufactured by Sigma-Aldrich Co.), 10 parts by weight of copper phthalocyanine particles (with an average particle diameter of 0.26 μm, a particle size distribution of 4.0, and a specific gravity of 1.57), 0.3 parts by weight of a dispersing agent (phenylsulfonic acid), and 60 parts by weight of methyl ethyl ketone, as a solvent, were mixed and kneaded using a kneader, and then the components of the kneaded substance were dispersed using a sand mill. Then, 5 parts by weight of an isocyanate compound (TAKENATE D110-N, trade name, manufactured by Mitsui Chemicals Polyurethanes, Inc.) and 20 parts by weight cyclohexanone, as a solvent, were mixed into the obtained dispersion liquid, thereby forming a coating liquid (Resin Composition 1).

Resin Composition 1 was applied on the PET substrate using a rod bar so that a dried film having a thickness of 1.5 μm was to be obtained, and dried at 50° C. for 3 minutes. Then, the mask was gently attached to the surface of the PET substrate on which the resin composition had been coated and dried, and further maintained at room temperature for two days. To measure the amount of the isocyanate remaining after the storage, the infrared absorption spectrum was measured using an FT-IR spectrometer, but no isocyanate-induced absorption was observed. In addition, results of the dynamic viscoelastic measurement performed while the PET substrate remained attached to the polymer film mask showed a maximum value of broad loss tangent near 10° C.; therefore, the Tg of the polymer film mask was assumed to be approximately 10° C.

In the obtained mask for surface processing, a coverage of the particles in the polymer film mask was about 20%, and the obtained mask for surface processing showed an adhesion force that acts between the polymer film mask and a supporting substrate of about 1.0 N/10 mm.

Surface processing was performed in the following manner using the obtained mask for surface processing to form recesses and protrusions on the surface of a silicon substrate (having a diameter of 100 mm and a thickness of 0.3 mm), which was an object to be processed.

First, the mask for surface processing was stacked on the surface of the silicon substrate to make the polymer film mask face the silicon substrate. Next, the silicon substrate on which the mask for surface processing had been stacked was inserted into a laminating apparatus, and pinched with pinch rollers at a temperature of 50° C. under a vacuum and reduced pressure (50 hPa) condition so as to weld the mask for surface processing (polymer film mask) and the silicon substrate. Then, the supporting substrate was released from the polymer film mask. In this way, the polymer film mask was attached to the surface of the silicon substrate.

Next, the silicon substrate attached to the polymer film mask was dry-etched in the presence of SF₆ gas at 150 W for 30 seconds. After purging with nitrogen gas, surface processing of the dry-etched silicon substrate was performed using an oxygen plasma at 300 W for 30 seconds by injecting an oxygen gas. The surface of the surface-processed silicon substrate was observed with a scanning electron microscope (SEM) and the AFM, and it was observed that the surface of the silicon substrate had recess portions with a diameter of about 0.5 μm and a depth of about 0.2μ (a recess and protrusion structure). The ‘diameter’ as used herein refers to an equivalent diameter, exhibited by at least 60% of the total recess portions on the surface of the silicon substrate.

### Example 2

The polymer film mask was stacked on the surface of the silicon substrate in the same manner as in Example 1. As a result of performing surface processing in the same manner as in Example 1 except that dry etching was performed at 150 W for 60 seconds in the presence of SF₆ gas, it was observed that recesses and protrusions with a diameter (equivalent diameter) of about 0.5 μm and a depth of about 0.5 μm were formed on the surface of the silicon substrate.

### Example 3

The polymer film mask was stacked on the surface of the silicon substrate in the same manner as in Example 1. As a result of performing surface processing in the same manner as in Example 1 except that dry etching was performed at 150 W for 90 seconds in the presence of SF₆ gas, it was observed that recesses and protrusions with a diameter (equivalent diameter) of about 1 μm and a depth of about 1 μm were formed on the surface of the silicon substrate.

### Example 4

The polymer film mask was stacked on the surface of the silicon substrate in the same manner as in Example 1 except that 50 parts by weight of Resin Composition 1 and 110 parts by weight of cyclohexanone were used. As a result of performing surface processing in the same manner as in Example 1 except that dry etching was performed at 150 W for 60 seconds in the presence of SF₆ gas, it was observed that recesses and protrusions with a diameter (equivalent diameter) of about 0.2 μm and a depth of about 0.4 μm were formed on the surface of the silicon substrate.

### Example 5

First, a mask for surface processing was produced in the following manner.

A PET substrate substantially the same as the substrate prepared in Example 1 was prepared. The following Resin Composition 2 was applied on the PET substrate and irradiated with an ultraviolet ray, using a high pressure mercury vapor lamp irradiator, in a nitrogen gas atmosphere to the extent that the cumulative quantity of light reached 2000 mJ/cm² at the wavelength of 365 nm, thereby forming a polymer film mask (a polymethyl(meth)acrylate film in which titanium oxide particles were mixed and dispersed) having a thickness of 1.5 μm. In this way, a mask for surface processing was produced.

Resin Composition 2

9 parts by weight of an ultraviolet curable resin having a glass transition temperature after being cured of 30° C. (a mixture of 50 parts by weight of LIGHT ACRYLATE 1,6-HX-A, 25 parts by weight of TMP-A, 25 parts by weight of DCP-A (all trade names; unsaturated addition polymerizable polymers manufactured by Kyoeisha Chemical Co., Ltd.), and 7.5 parts by weight of DAROCUR 1173 (trade mark, manufactured by Nihon Ciba-Geigy K.K.), which was an initiator) and 10 parts by weight copper phthalocyanine particles (having an average particle diameter of 0.26 μm, a particle size distribution of 4.0, and a specific gravity of 1.57) were mixed and kneaded using a kneader. Then, 0.6 parts by weight of a dispersing agent (phenylsulfonic acid) and 100 parts by weight of a solvent (methyl ethyl ketone) were added to the kneaded product, and the kneaded components were dispersed by using a sand mill, thereby obtaining Resin Composition 2.

The obtained mask for surface processing showed a coverage of the particles on the polymer film mask of 56% and an adhesion force between the polymer film mask and the supporting substrate of 1 N/10 mm.

By using the obtained mask for surface processing, recesses and protrusions were formed on the surface of the silicon substrate in the same manner as in Example 1 except that the laminating temperature was 80° C. and the dry etching time was 60 seconds.

### Example 6

As a result of stacking the polymer film mask on the surface of the silicon substrate and performing surface processing in the same manner as in Example 1 except that C. I. Pigment Red 22 was used instead of the copper phthalocyanine particles of Resin Composition 1, it was observed that recesses and protrusions having a diameter (equivalent diameter) of about 1 μm and a depth of about 0.5 μm were formed on the surface of the silicon substrate.

### Example 7

As a result of stacking the polymer film mask on the surface of the silicon substrate and performing surface processing in the same manner as in Example 1 except that oxonol dye particles represented by the following chemical formula were used instead of the copper phthalocyanine particles of Resin Composition 1, it was observed that recesses and protrusions having a diameter (equivalent diameter) of about 1 μm and a depth of about 0.5 μm were formed on the surface of the silicon substrate.

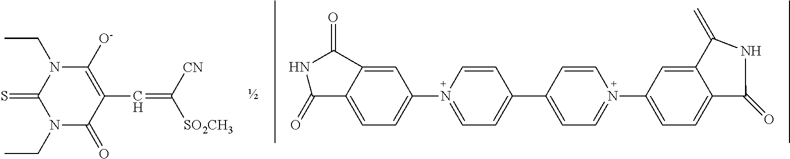

### EXPLANATION OF REFERENCES

10 Mask for Surface Processing
11 SUPPORTING SUBSTRATE
12 POLYMER FILM MASK
12A BINDING RESIN
12B ORGANIC PIGMENT PARTICLES
20 SUBSTRATE TO BE PROCESSED
30 LAMINATING APPARATUS
31 PINCH ROLLERS

1. A surface processing method for forming recesses and protrusions on a surface of an object to be processed, comprising:
attaching a polymer film mask on a surface of the object to be processed, the polymer film mask comprising a binding resin and organic pigment particles which are included in the binding resin, and
etching the surface of the object to be processed to which the polymer film mask has been attached to form recesses and protrusions on the surface of the object to be processed.

2. The surface processing method according to claim 1, wherein a ratio of a projected area of the organic pigment particles projected to a substrate to be processed in an etching direction with respect to a surface area of the substrate to be processed is from 5% to less than 60%.

3. The surface processing method according to claim 1, wherein a glass transition temperature of the binding resin is 50° C. or less.

4. The surface processing method according to claim 3, wherein:
one principal surface of the polymer film mask is supported by a supporting substrate; and
the etching includes attaching the polymer film mask on the surface of the object to be processed so as to make the opposite surface to the principal surface face the object to be processed and then releasing the supporting substrate from the polymer film mask.

5. The surface processing method according to claim 4, wherein an adhesion force that acts between the polymer film mask and the supporting substrate is 5 N/10 mm or less at 25° C.

6. The surface processing method according to claim 5, wherein a thermoplastic resin layer having a thickness of less than 15 μm is placed between the polymer film mask and the supporting substrate.

7. The surface processing method according to claim 6,
the surface of the polymer film mask opposite to the surface on which the supporting substrate is provided is covered with a protection film; and
the protection film is released from the polymer film mask before attaching the polymer film mask on the surface of the object to be processed.

8. The surface processing method according to claim 7, wherein attaching the polymer film mask on the surface of the object to be processed includes attaching the polymer film mask and the object to be processed by pinching them with rollers under a condition of at least either of a vacuum or reduced pressure condition or a temperature condition higher than that of the glass transition temperature of the binding resin.

9. The surface processing method according to claim 8, wherein the etching comprises dry etching.

10. The surface processing method according to claim 9, wherein:
a ratio of a number of recess portions on the surface of the object to be processed having an equivalent diameter in a range of from 200 nm to 1,000 nm with respect to a total number of recess portions on the surface of the object to be processed is 60% or greater; and
the equivalent diameter is a diameter of a circle having the same area as an area surrounded by a line drawn on an inside surface of the recess portion at 10% depth from a reference surface toward a bottom of the recess portion, in which the reference surface refers to a flat area where no recess or protrusion is formed on the processed surface of the object to be processed.

11. The surface processing method according to claim 10, wherein the surface of the object to be processed on which recesses and protrusions are formed is a light incidence surface of an optical device.

12. A mask for surface processing for forming recesses and protrusions on a surface of an object to be processed, comprising a polymer film mask comprising a binding resin and organic pigment particles which are included in the binding resin.

13. The mask for surface processing according to claim 12, further comprising a supporting substrate that supports one principal surface of the polymer film mask.

14. The mask for surface processing according to claim 13, wherein a thermoplastic resin layer having a thickness of less than 15 μm is placed between the polymer film mask and the supporting substrate.

15. The mask for surface processing according to claim 14, further comprising a protection film that covers a surface of the polymer film mask opposite to the surface on which the supporting substrate is provided.

16. The mask for surface processing according to claim 15, wherein the mask is shaped as a roll or a sheet.

17. An optical device, comprising a substrate which has been processed by the surface processing method according to claim 11.
